(19) United States
(12) Patent Application Publication
(10) Pub. No.: US 2010/0239856 A1
(43) Pub. Date: Sep. 23, 2010

(54) Continuous Fiber Reinforced Thermoplastic Parts With In-Situ Molded Features

(76) Inventors: Paul Douglas Olson, Camarillo, CA (US); Mark Jennings, Newbury Park, CA (US); Raul Ayala, Oxnard, CA (US); David Wharton, Newbury Park, CA (US)

Correspondence Address: SHELDON MAK ROSE & ANDERSON PC, 100 Corson Street, Third Floor, PASADENA, CA, 91103-3842, US

(21) Appl. No.: 12/408,206

(22) Filed: Mar. 20, 2009

(51) Int. Cl. B32B 17/10; B29C 70/40; B32B 27/36

(52) U.S. Cl. 428/339; 264/258; 428/522; 428/430

(57) ABSTRACT

A method for producing parts comprising the steps of: preparing a thermoplastic composite base; preparing build up areas on the base for in situ molded features to form a kit; inserting the kit into a compression mold; applying heat and pressure to the kit in the compression mold; and removing the finished part from the compression mold.

### BACKGROUND

The present invention is directed to thermoplastic parts, and more particularly to fiber reinforced thermoplastic parts with in-situ molded features.

Compression molding is a method of forming an object in which the molding material is generally preheated and placed in an open, heated mold cavity. The mold is then closed and pressure is applied to force the material into contact with all mold areas. Heat and pressure are maintained until the molding material has cured or cooled. Compression molding of thermoplastic and thermoset composites has been used for several years to make several types of parts. Compression molding is suitable for molding complex, high-strength fiberglass reinforcements, and it is also known that advanced composite thermoplastics can be compression molded with unidirectional tapes, woven fabrics, randomly orientated fiber mat or chopped strand. Compression molding works well for large thick parts but is difficult for thin detailed structures, and it is also known as a lower cost molding method, when compared with other methods such as injection molding. However, compression molding often provides poor product consistency and difficulty in controlling flashing, and it is not suitable for some types of parts, especially those with intricate detail structure.

Injection molding is another manufacturing process for producing objects from thermoplastic and thermosetting plastic materials. In an injection molding process, material is fed into a heated barrel, mixed, and forced into a mold cavity where it cools and hardens to the configuration of the mold cavity. Intricate parts may be formed with injection molding by preparing a mold that is precision-machined to form the features of the desired object. Injection molding is widely used for manufacturing a variety of parts, from the smallest component to entire body panels of cars. However, fine, ready for paint finishes on complex parts has proven difficult to obtain with injection molding.

Plastic injection molding, composite compression molding, investment casting and liquid injection molding of non-ferrous metals have all been used to make complex detailed electronic enclosures. Each of these processes can make thin detailed electronic enclosures. However, each makes a part deficient in detail, strength, stiffness, weight or cost. Plastic parts can be made that are low cost and very detailed, but the part lacks the strength and stiffness. Compression molded composite parts can be strong and stiff but heavier, less detailed and costly. Investment cast and liquid injection molded parts are heavier, weaker, and insufficiently stiff.

Thus, there is a need for a method for producing lighter, stiffer, stronger parts with injection molding like design details and a fine, paint ready finish. There is also a need for a method that allows mass production with the cost advantages ascribed to high volume fabrication.

### SUMMARY

According to the present invention, there is provided an improved method for producing lighter, stiffer, stronger parts with injection molding like design details and a fine, paint ready finish. In an embodiment, the method for producing parts has the steps of: preparing a thermoplastic composite base; preparing build up areas on the base for in situ molded features to form a kit; inserting the kit into a compression mold; applying heat and pressure to the kit in the compression mold; and removing the finished part from the compression mold.

The build-up areas may be attached to the base prior to inserting the kit into the compression mold. The kit may have a plurality of layers of continuous fiber reinforced thermoplastic tape. The kit may have a thermoplastic foam sheet, a thermoplastic honeycomb or a thermoplastic film. The build-up areas may comprise the same thermoplastic composite as the base. Additionally, the build up areas comprise a different thermoplastic composite than the base.

In an embodiment, the kit has a thermoplastic and a continuous fiber. The thermoplastic may be selected from the group consisting of polyethylene terephthalate (PET), acrylonitrile butadiene styrene-polycarbonate(ABS-PC), polypropylene, polylactic acid (PLA), polyamide, polyphenylene sulfide) (PPS), polyether imide (PEI), polybutylene terephthalate (PBT), polyphenylene ether-polystyrene (PPE+PS) and polyetheretherketone (PEEK). The continuous fiber may be selected from the group consisting of carbon, glass, basalt, bast, hemp, flax and Kevlar. In a particular embodiment, the thermoplastic is polyethylene terephthalate and the continuous fiber is carbon.

In an embodiment, the heat applied to the kit in the compression mold is from about 220° C. to about 400° C. In an additional embodiment, the heat applied to the kit in the compression mold is from about 220° C. to about 350° C. In an embodiment, the pressure applied to the kit in the compression mold is from about 200 psi to about 2000 psi. In an additional embodiment, the pressure applied to the kit in the compression mold is from about 500 psi to about 1500 psi.

The present invention is also directed to a part made using the method of present invention. In particular, the present invention, according to an embodiment, is directed to a composite part having a thermoplastic resin; a continuous fiber and at least one continuous fiber reinforced detailed feature. The at least one continuous fiber reinforced detailed features may have a thickness of less than about 0.5 inches. Additionally, the at least one continuous fiber reinforced detailed feature may have a thickness of less than about 0.1 inch. Additionally, the at least one continuous fiber reinforced detailed feature may have a thickness of less than about 0.05 inches.

The thermoplastic resin in the part may be selected from the group consisting of: polyethylene terephthalate (PET), acrylonitrile butadiene styrene-polycarbonate(ABS-PC), polypropylene, polylactic acid (PLA), polyamide, polyphenylene sulfide) (PPS), polyether imide (PEI), polybutylene terephthalate (PBT), polyphenylene ether-polystyrene (PPE+PS) and polyetheretherketone (PEEK). The fiber in the part may be selected from the group consisting of: carbon, glass, basalt, bast, hemp, flax and Kevlar. In a particular embodiment, the thermoplastic in the part is polyethylene terephthalate and the continuous fiber in the part is carbon. The part may be formed from a kit having a plurality of lamina of variably oriented fibers.

### FIGURES

These and other features, aspects and advantages of the present invention will become better understood from the following description, appended claims, and accompanying figures where:

FIG. 1 is a flowchart showing a method of making continuous fiber reinforced thermoplastic parts with in-situ molded features according to one embodiment of the present invention;

FIG. 2 is a flowchart illustrating preparation of a thermoplastic composite laminate usable for making continuous fiber reinforced thermoplastic parts according to an embodiment of the present invention;

FIG. 3 is an exploded view of a thermoplastic composite laminate usable for making continuous fiber reinforced thermoplastic parts according to an embodiment of the present invention;

FIG. 4 is a perspective view of a kit for making continuous fiber reinforced thermoplastic parts according to an embodiment of the present invention;

FIG. 5 is a cross sectional view of the kit of FIG. 3 taken along line A-A;

FIG. 6 is a perspective view of a finished part made according to the present invention;

FIG. 7 is an enlarged view of a detailed feature of the finished part of FIG. 5; and

FIG. 8 is a cross-sectional view through the detailed feature of FIG. 6.

### DESCRIPTION

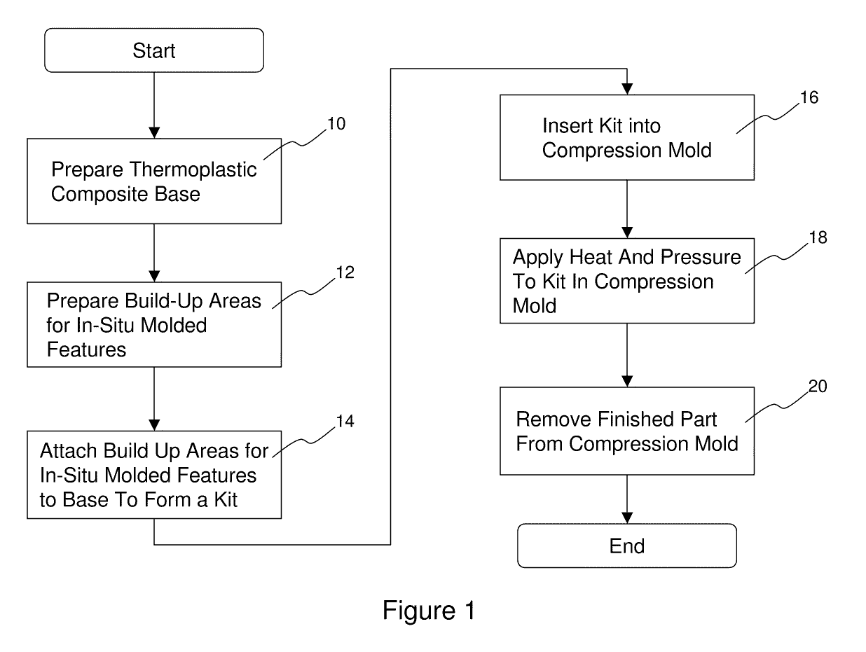

According to one embodiment of the present invention, with reference to FIG. 1, there is provided a method of making continuous fiber reinforced thermoplastic parts with in-situ molded features. The method comprises the steps of: preparing a thermoplastic composite base 10, preparing build-up areas for in-situ molded features 12, coupling the build-up areas for in-situ molded features to the base to form a kit 14, inserting the kit into a compression mold 16, applying heat and pressure to the kit in the compression mold 18, and removing the finished part from the compression mold 20. Following removal of the finished part from the compression mold, the part may be trimmed, drilled, tapped or painted as desired.

As used herein the term “composite” means a solid material which is composed of two or more substances having different physical characteristics and in which each substance retains its identity while contributing desirable properties to the whole. The present invention, according to various embodiments, uses composites composed of 1) a thermoplastic resin such as polyethylene terephthalate (PET), acrylonitrile butadiene styrene-polycarbonate(ABS-PC), polypropylene, polylactic acid (PLA), polyamide, polyphenylene sulfide) (PPS), polyether imide (PEI), polybutylene terephthalate (PBT), polyphenylene ether-polystyrene (PPE+PS) and polyetheretherketone (PEEK); and 2) a continuous fiber such as; carbon, glass, basalt, bast, hemp, flax and Kevlar®. Thermoplastic resins allow the composite to be heated and molded within seconds in contrast to thermoset resins such as epoxy that require heat and a chemical reaction which can take several minutes. Thermoplastic composites usable in this invention may include, for example, unidirectional strips, comingled yarns or fabrics, woven unidirectional tapes or pre-consolidated fabrics. Discontinuous fiber composites may be used, but are likely to lead to weaker finished parts.

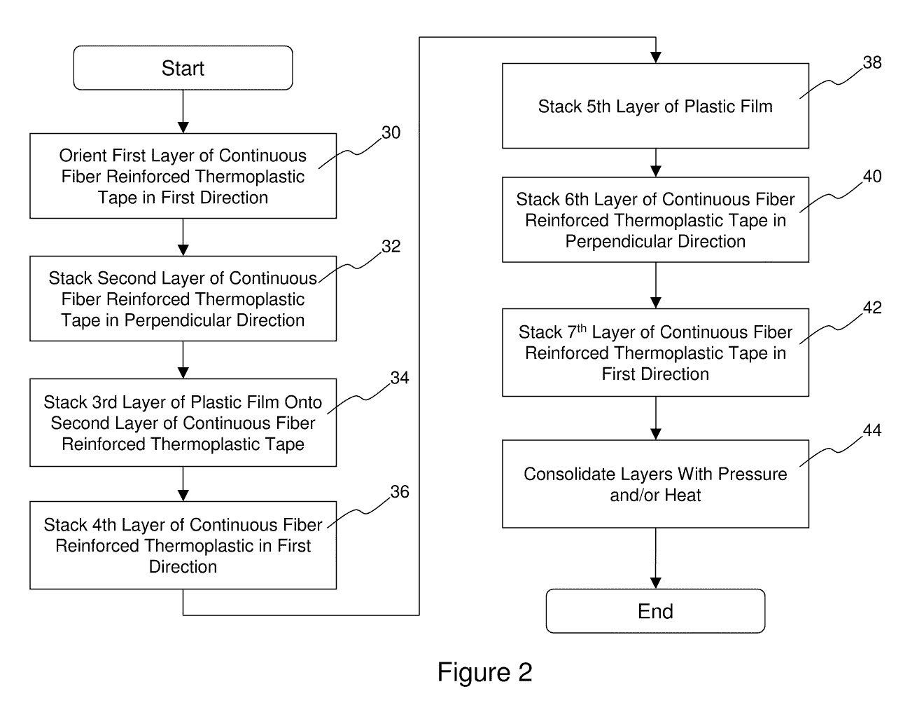

The steps of preparing a thermoplastic composite base and build-up areas will now be considered in more detail with reference to FIGS. 2 to 8. The thermoplastic composite base may be formed of strategically placing and stacking layers of material and lightly consolidating the layers using heat and/or pressure. The layers may be of the same material or of different materials. Each layer may be, for example, a thermoplastic composite, compatible foam sheet, honeycomb or thermoplastic film. Each layer may be strategically placed to optimize the strength, stiffness and weight of the finished part. This may include different materials in different areas of the same layer to provide the different areas with different properties. The materials are assembled and cut to a proper volume and shape to fill the mold.

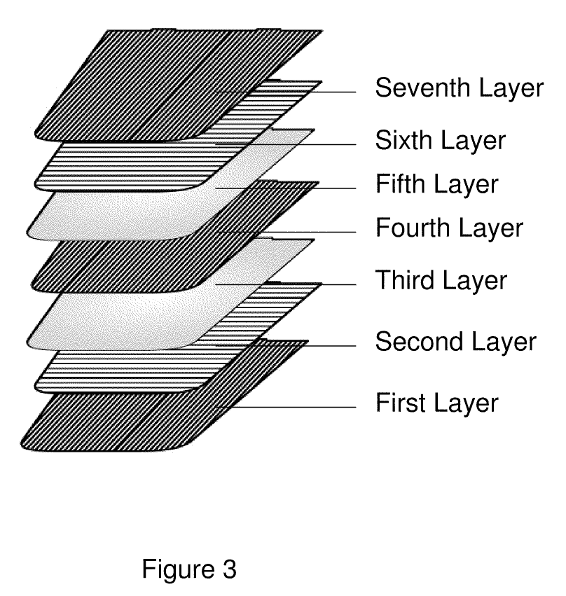

A flowchart illustrating preparation of a thermoplastic composite laminate according to an embodiment of the present invention utilizing continuous fiber reinforced thermoplastic tape is shown in FIG. 2. The resulting laminate is usable for the base and/or the build-up portions of the kit. An exploded view of the different layers in the laminate is shown in FIG. 3. The embodiment shown in FIGS. 2 and 3, and described below, illustrates an example of the invention; one of skill in the art will recognize that the materials used and the thicknesses of the layers may be varied to achieve desired weights and strength characteristics of the final product.

A suitable continuous fiber reinforced thermoplastic tape may be, for example, a unidirectional PET/Carbon tape which is 0.006″ thick and 50% by weight carbon fiber. A first layer of continuous fiber reinforced thermoplastic tape is oriented in a first direction 30. Optionally, the first layer is placed on a platen and a release layer, such as a polytetrafluoroethylene (PTFE) glass fabric, is placed between the first layer and the first platen to prevent sticking of the first layer to the first platen. A second layer, consisting of continuous fiber reinforced thermoplastic tape, is stacked on top of the first layer, but in a perpendicular direction 32. A third layer, consisting of plastic film that is 0.010″ thick made from the same PET resin, is placed on top of the second layer, the plastic film having the same thermoplastic as the CFRT tape of the first and second layers 34.

A fourth layer, consisting of continuous fiber reinforced thermoplastic tape, is placed on top of the third layer in the first direction 36. A fifth layer, consisting of plastic film, is placed on top of the fourth layer, the plastic film having the same thermoplastic as the continuous fiber reinforced thermoplastic tape used in previous layers 38. A sixth layer, consisting of continuous fiber reinforced thermoplastic tape, is placed on top of the fifth layer in the perpendicular direction 40. A seventh layer, consisting of continuous fiber reinforced thermoplastic tape, is placed on top of the sixth layer in the first direction 42. Optionally, a release layer, such as a PTFE glass fabric, may be placed on the seventh layer.

The layers may be consolidated in 20 seconds using light contact pressure and heat sufficient to bond the layers together to form the laminate. The pressure used to consolidate the layers may vary with the materials used, but with PET is preferably from about 5 to about 50 psi, and more preferably from about 5 to about 15 psi. The heat used to consolidate the layers may vary with the materials used, but with PET is preferably from about 425° F. to about 475° F.

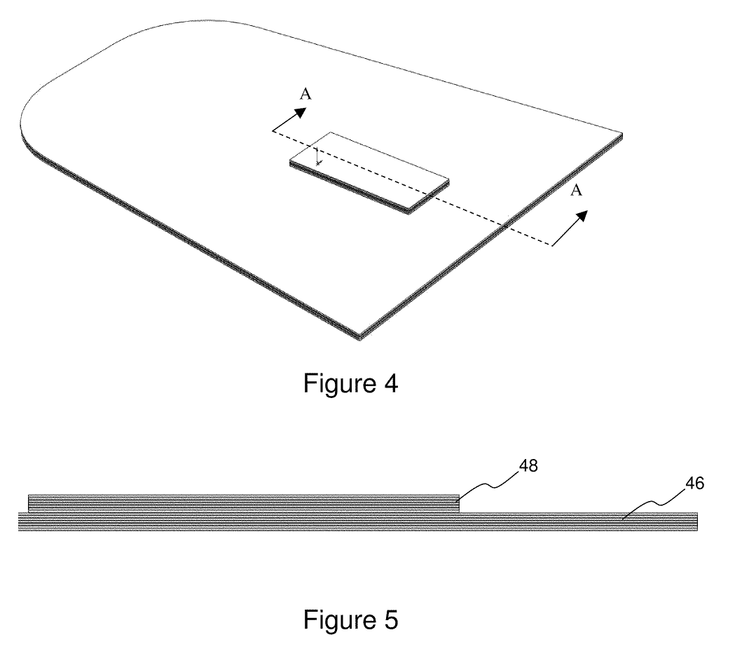

As shown in FIGS. 4 and 5, the laminate described above or other chosen material for the base is shaped, such as by cutting, to form a base 46. Build-ups 48 are then placed on top of the base 46. The build-ups 48 may be made from the same material as the base or from a different material. The use of a plastic film between layers of fiber reinforced thermoplastic tape, as described above, and the use of composites with higher thermoplastic resin content may help the continuous fibers flow into the resulting detailed features.

Careful placement of build-up material in areas of in-situ molding of detailed features, such as a screw boss, support or standoff, is important to the quality of the finished part. Shorter strips of continuous fiber reinforced thermoplastics may be used for the build-up areas with the length being defined by dimensions of the detailed features so that continuous fiber reinforcement is provided throughout the detailed features.

In a preferred embodiment of the present invention, the build-ups are attached to the base by welding to form the kit. A heated soldering iron with a large flat tip pressed briefly against each build-up may be used to attach the build-ups it to the base. Alternatively, a hot-melt glue can be used as means of attaching the build up. The hot-melt glue can be of the same thermoplastic used in the kit. Alternatively, the hot-melt glue can be a crosslinking polymer. Attaching the build-ups to the base increases the durability and stability of the kit when the kit is placed in the compression mold and allows for accurate placement of the build-ups.

The kit is then placed in the compression mold. Suitable compression molding systems are well known in the art. When applying heat and pressure to the kit while the kit is in the compression mold, the fiber flows with the thermoplastic resin to fill the mold to the desired shape. The heat and pressure applied to the kit in the compression mold depends at least partly on the thermoplastic composite used for the kit. In an embodiment, the heat applied to the kit in the compression mold is from about 220° C. to about 350° C., and more preferably from about 220° C. to about 250° C. In an embodiment, the pressure applied to the kit in the compression mold is from about 200 psi to about 2000 psi, and more preferably, from about 500 psi to about 1500 psi.

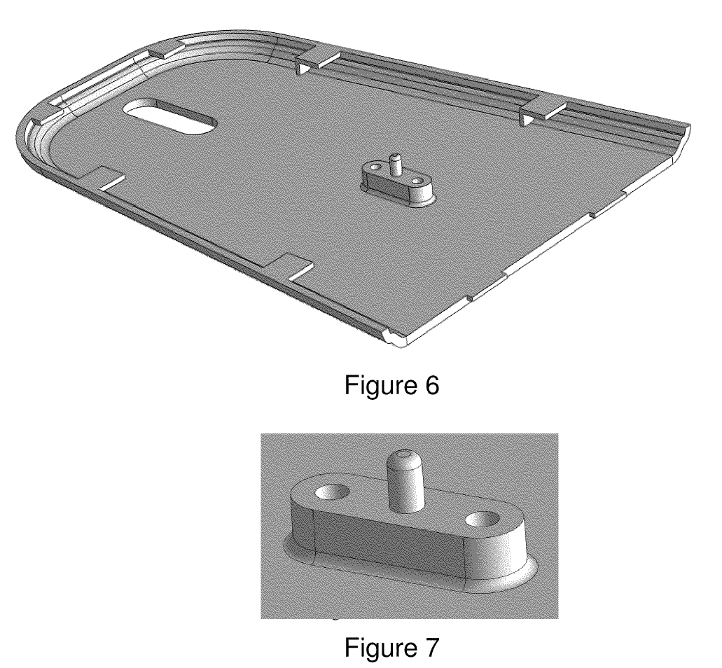

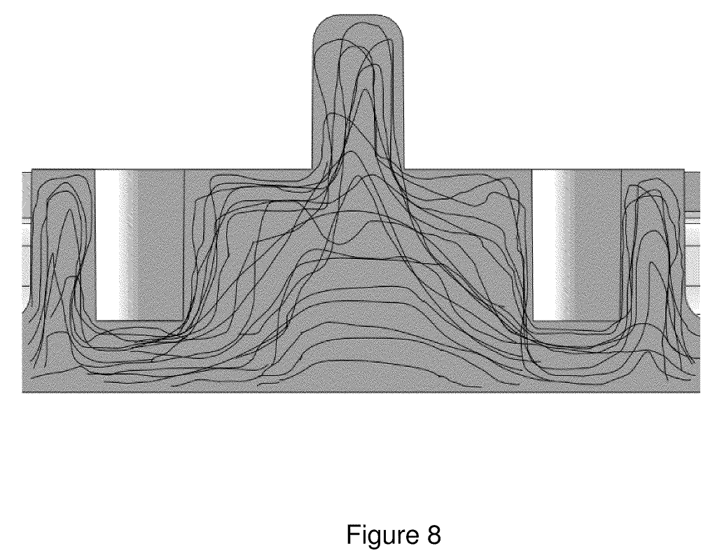

The kit of FIGS. 4 and 5 fill the mold and result in the finished part shown in FIGS. 6 and 7. The finished part is a fiber reinforced structure that is several times stronger than a similar structure formed only from thermoplastic resin. Importantly, even the detailed features of the finished part, such as the boss shown in FIG. 7, are much stronger than similar structures formed from only thermoplastic resin. As shown in FIG. 8, the increased strength of the detailed features is due to continuous fiber reinforcement of the detailed featured themselves.

The present invention is also directed to continuous fiber reinforced thermoplastic parts having continuous fiber reinforced detailed features. Typical detailed features include bosses, stand-offs, alignment pins and wave guides. Preferably, at least one of the continuous fiber reinforced detailed features has a thickness in at least one dimension of less than about 0.5 inches, more preferably less than 0.10″ inches and even more preferably less than about 0.05 inches.

The methods of the present invention according to specific embodiments, can be used to efficiently produce many different kinds of parts. For example, parts can be made for: consumer products, such as vacuum cleaners; industrial products, such as cases and housings for electronics as well as fans and vanes; aircraft, such as seat frame structures and window frames; recreational products, such as snow board and ski bindings; automotive products, such as oil pans, seat structures and dashboard structures; boat products, such as propellers; and medical products, such as gurney frames. In sum, the present invention provides for mass production of light weight, stiff, and strong products with in-situ molded features.

Although the present invention has been discussed in considerable detail with reference to certain preferred embodiments, other embodiments are possible. Therefore, the spirit and scope of the appended claims should not be limited to the description of preferred embodiments contained herein.

All features disclosed in the specification, including the claims, abstracts and drawings, and all the steps in any method or process disclosed, may be combined in any combination except combination where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1. A method for producing parts comprising the steps of:
a. preparing a thermoplastic composite base;
b. preparing build up areas on the base for in situ molded features to form a kit;
c. inserting the kit into a compression mold;
d. applying heat and pressure to the kit in the compression mold; and
e. removing the finished part from the compression mold.

2. The method for producing parts of claim 1 further comprising the step of attaching the build up areas to the base.

3. The method for producing parts of claim 1 wherein the kit comprises a plurality of layers of continuous fiber reinforced thermoplastic tape.

4. The method for producing parts of claim 1 wherein the build up areas comprise the same thermoplastic composite as the base.

5. The method for producing parts of claim 1 wherein the build up areas comprise a different thermoplastic composite than the base.

6. The method for producing parts of claim 1 wherein the kit comprises:
a. a thermoplastic; and
b. a continuous fiber.

7. The method for producing parts of claim 6 where the thermoplastic is selected from the group consisting of polyethylene terephthalate (PET), acrylonitrile butadiene styrene-polycarbonate(ABS-PC), polypropylene, polylactic acid (PLA), polyamide, polyphenylene sulfide) (PPS), polyether imide (PEI), polybutylene terephthalate (PBT), polyphenylene ether-polystyrene (PPE+PS) and polyetheretherketone (PEEK).

8. The method for producing parts of claim 6 wherein the continuous fiber is selected from the group consisting of carbon, glass, basalt, bast, hemp, flax and Kevlar.

9. The method for producing parts of claim 6 wherein the thermoplastic is polyethylene terephthalate and the continuous fiber is carbon.

10. The method for producing parts of claim 1 wherein the heat applied to the kit in the compression mold is from about 220° C. to about 350° C.

11. The method for producing parts of claim 1 wherein the heat applied to the kit in the compression mold is from about 220° C. to about 250° C.

12. The method for producing parts of claim 1 wherein the pressure applied to the kit in the compression mold is from about 200 psi to about 2000 psi.

13. The method for producing parts of claim 1 wherein the pressure applied to the kit in the compression mold is from about 500 psi to about 1500 psi.

14. The method for producing parts of claim 1 wherein the kit comprises at least one of: a thermoplastic foam sheet, a thermoplastic honeycomb and a thermoplastic film.

15. A part made using the method of claim 1.

16. A composite part comprising:
a. a thermoplastic resin; and
b. a continuous fiber;
wherein the part further comprises at least one continuous fiber reinforced detailed feature.

17. The composite part of claim 16 wherein the at least one continuous fiber reinforced detailed features has a thickness of less than about 0.5 inches.

18. The composite part of claim 16 wherein the at least one continuous fiber reinforced detailed features has a thickness of less than about 0.1 inch.

19. The composite part of claim 16 wherein the at least one continuous fiber reinforced detailed features has a thickness of less than about 0.05 inches.

20. The composite part of claim 16 wherein the thermoplastic resin is selected from the group consisting of: polyethylene terephthalate (PET), acrylonitrile butadiene styrene-polycarbonate(ABS-PC), polypropylene, polylactic acid (PLA), polyamide, polyphenylene sulfide) (PPS), polyether imide (PEI), polybutylene terephthalate (PBT), polyphenylene ether-polystyrene (PPE+PS) and polyetheretherketone (PEEK).

21. The composite part of claim 16 wherein the continuous fiber is selected from the group consisting of: carbon, glass, basalt, bast, hemp, flax and Kevlar.

22. The composite part of claim 16 wherein the part is formed from a kit comprising a plurality of lamina of variably oriented continuous fibers.

23. The composite part of claim 16 wherein the thermoplastic is polyethylene terephthalate and the continuous fiber is carbon.
